(19) United States
(12) Patent Application Publication
(10) Pub. No.: US 2008/0040371 A1
(43) Pub. Date: Feb. 14, 2008

(54) Generic architecture for providing data to flash model

(76) Inventors: Pavan Bayyapu, Sunnyvale, CA (US); Gautam Dharamshi, Mountain View, CA (US)

Correspondence Address: FISH & RICHARDSON, P.C., PO BOX 1022, MINNEAPOLIS, MN, 55440-1022, US

(21) Appl. No.: 11/502,986

(22) Filed: Aug. 11, 2006

(51) Int. Cl. G06F 7/00

(52) U.S. Cl. 707/101

(57) ABSTRACT

In general, the disclosure includes managing foreign data from multiple sources. In one embodiment, a software application is operable to receive a request for a display page including data foreign to a Flash application embedded in the display page. In response to at least the request, the technical information for retrieving the foreign data is automatically identified. Foreign data is retrieved from at least one foreign data source in accordance with the technical information. The foreign data is translated to a form compatible with the Flash application based, at least in part, on the technical information.

### TECHNICAL FIELD

This invention relates to data management and, more particularly, to managing foreign data from multiple sources.

### BACKGROUND

Macromedia Flash is used to create vector graphics-based animation programs with full-screen navigation interfaces, graphic illustrations, and simple interactivity in an antialiased, resizable file format that is small enough to stream across a normal modem connection. The software is ubiquitous on the Web, both because of its speed (vector-based animations, which can adapt to different display sizes and resolutions, play as they download) and for the smooth way it renders graphics. Flash files, unlike animated but rasterized GIF and JPEG, are compact, efficient, and designed for optimized delivery. Typically, Flash is used to embed animations in web pages.

In response to demand for improved user experiences, Rich Internet Applications have emerged, which provide the responsiveness and interactivity of desktop applications with the ease of distribution of web applications. Macromedia Flex augments existing HTML generation with executable code that runs on the client to provide Rich Internet Applications. Flex includes programming methodology and workflow with a class library for creating the presentation tier.

### SUMMARY

In general, the disclosure includes managing foreign data from multiple sources. In one embodiment, a software application is operable to receive a request for a display page including data foreign to a Flash application embedded in the display page. In response to at least the request, the technical information for retrieving the foreign data is automatically identified. Foreign data is retrieved from at least one foreign data source in accordance with the technical information. The foreign data is translated to a form compatible with the Flash application based, at least in part, on the technical information.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a data management system in accordance with one embodiment of the present disclosure;

FIG. 2 is a server processor of FIG. 1 in accordance with one embodiment of the present disclosure;

FIG. 3 is a flow diagram illustrating an example display page including embedded Flash applications; and

FIG. 4 is a flow diagram illustrating an example method for integrating foreign data with a Flash application.

### DETAILED DESCRIPTION

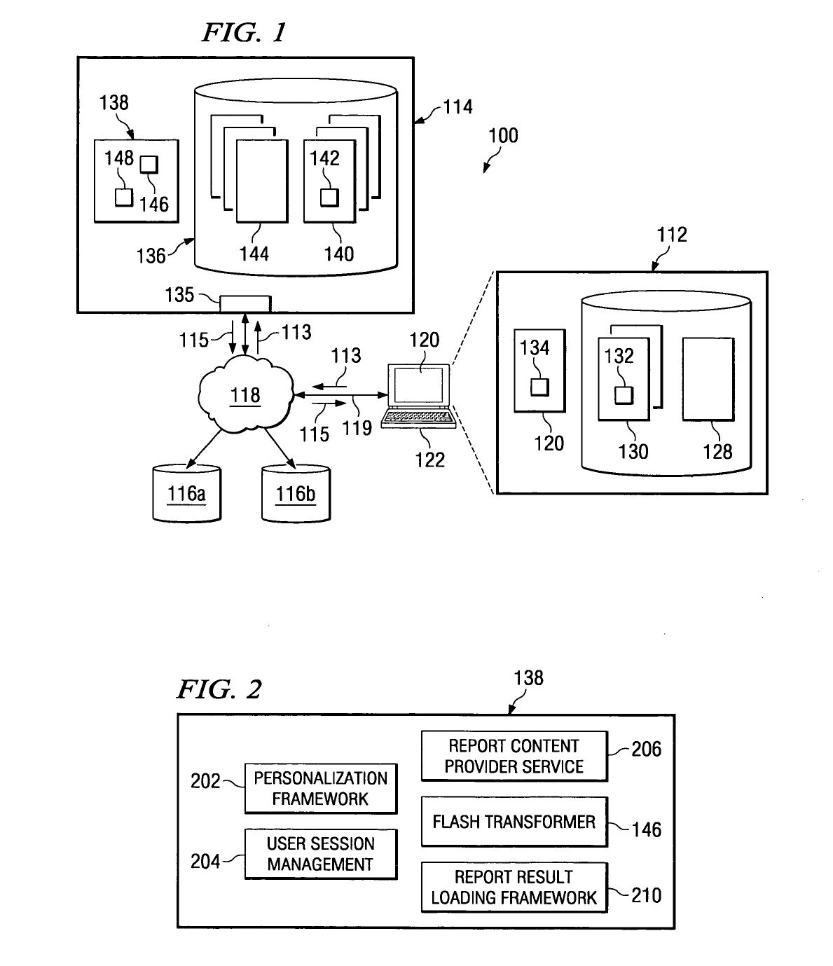

FIG. 1 illustrates a data management system 100 for interfacing foreign data with a Flash player 128. Foreign, as used herein, means any component, object, value, variable, and/or data and/or data schema that is not directly processible, accessible, or otherwise capable of communicating with Flash player 128. Indeed, this foreign data is merely in terms of Flash player 128—in other words, the foreign data is typically remote to Flash player 128 but may be local to system 100 or even physically resident on the same computer as Flash player 128. In general, system 100 is operable to translate information from foreign data sources 116 to a form compatible with Flash player 128 while technical details remain hidden from the user. Flash player 128 may then execute the Flash application associated with the foreign data. In the illustrated embodiment, the Flash application 132 is embedded in display page 130, so the translated data may be presented in a portion of display page 130. In general, computer applications used for generic data extraction, reporting, and visualization, such as display engine 134, typically need to be able to access data from a wide variety of sources. For example, integration of foreign data with Flash player 128 may have been unanticipated at the time that foreign data sources 116 were developed and, as a result, foreign data sources 116 may be incompatible with Flash player 128. In addressing this incompatibility, system 100 may use application profiles 144 to provide a way of translating technical, logical, and integration-specific properties of foreign data sources 116 to a form compatible with Flash player 128. As a result, the foreign data may be processed by Flash player 128 and may allow Flash player 128 to present a user-friendly, descriptive interface for presenting foreign data without requiring the user to know technical details.

At a high level, system 100 is a distributed environment comprising client 112, server 114, and foreign data sources 116 communicably coupled via network 118. Client 112 may comprise a portion of an information management system operable to retrieve display pages 130, including an embedded Flash application 132, from server 114 for display through Graphical User Interface (GUI) 120. In this case, Flash application 132 may present foreign data to a user of client 112 such that the user may navigate, use, format, or otherwise understand and/or interact with the presented data without any required knowledge of its origin. Returning to the illustrated embodiment, client 112 includes GUI 120, a network interface 122, memory 124, and processor 126. The present disclosure includes a repository of display pages 130 including embedded Flash applications 132 that may be stored in memory 124 and may be processed by processor 126. FIG. 1 only provides one example of a computer that may be used with the disclosure. The present disclosure contemplates computers other than general purpose computers as well as computers without conventional operation systems. As used in this document, the term “computer” is intended to encompass a mainframe, a personal computer, a client, a server, a workstation, a network computer, a personal digital assistant, a mobile phone, or any other suitable local or remote processing device. Moreover, “client 112” and “user of client 112” may be used interchangeably as appropriate.

GUI 120 comprises a graphical user interface operable to allow the user of client 112 to interact with display engine 134 and/or Flash application 132. Generally, GUI 120 provides the user of client 112 with an efficient and user-friendly presentation of data provided by client 112. GUI 120 may comprise a plurality of displays having interactive fields, pull-down lists, and buttons operated by the user. And in one example, GUI 120 presents an explore-type interface and receives commands from the user. It should be understood that the term graphical user interface may be used in the singular or in the plural to describe one or more graphical user interfaces in each of the displays of a particular graphical user interface. Further, GUI 120 contemplates any graphical user interface, such as a generic web browser, that processes information in client 112 and efficiently presents the information to the user. In some embodiments, GUI 120 may present a web page embedding Flash content. In this case, the Flash content may provide a Rich Internet Application. Network 118 can accept data from the user of client 112 via the web browser (e.g., Microsoft Internet Explorer or Netscape Navigator) and return the appropriate Hyper Text Markup Language (HTML) or eXtensible Markup Language (XML) responses.

As appropriate, client 112 generates requests and/or responses and communicates them to another client, server, or other computer systems located in or beyond network 118. Network 118 facilitates wireless or wireline communication between client 112 and any other computer. Network 118 may communicate, for example, Internet Protocol (IP) packets, Frame Relay frames, Asynchronous Transfer Mode (ATM) cells, voice, video, data, and other suitable information between network addresses. Network 118 may include one or more local area networks (LANs), radio access networks (RANs), metropolitan area networks (MANs), wide area networks (WANs), all or a portion of the global computer network known as the Internet, and/or any other communication system or systems at one or more locations. Illustrated client 112 includes network interface 122 for communicating with other computer systems over network 118 such as, for example, in a client-server or other distributed environment via link 119. Generally, interface 122 comprises logic encoded in software and/or hardware in any suitable combination to allow client 112 to communicate with network 118 via link 119. More specifically, interface 122 may comprise software supporting one or more communications protocols associated with link 119 and communication hardware operable to communicate physical signals.

Memory 124 may include any memory or database module and may take the form of volatile or non-volatile memory including, for example, magnetic media, optical media, Random Access Memory (RAM), Read Only Memory (ROM), removable media, or any other suitable local or remote memory component. In the illustrated embodiment, memory 124 includes Flash player 128 and display pages 130. Flash player 128 is any suitable application running on client 112 that is operable to process Flash, Flash-like, or Flash-compatible executables for presenting information through GUI 120. In some embodiments, Flash player 128 comprises a Macromedia Flash Player. Flash player 128 may execute Small Web Format (SWF) files, which may be created by Macromedia Flash authoring tool, Macromedia Flex and/or a number of other Macromedia and/or third party tools. In this case, Flash player 128 may comprise a virtual machine that executes Flash files. Flash player 128 may perform one or more of the following functions: generate vector and/or raster graphics through GUI 120, process the native scripting language called ActionScript, or provide bidirectional streaming of video and audio. It will be understood that while player 128 is illustrated as a single multitasked module, the features and functionality performed by this engine may be performed by multiple modules. Moreover, player 128 may comprise a child or submodule of another software module, not illustrated, without departing from the scope of this disclosure. In short, Flash player 128 is any suitable software application or generic module that can process Flash files associated with display pages 130.

Based, at least in part, one or more display files 140 (discussed below), display pages 130 comprises any software component operable to receive and process requests, perform logic embedded in the associated display files 140, and generate dynamic or otherwise pages for display through GUI 120. In one embodiment, display page 130 comprises an executable HTML file. Display page 130 may be based on any suitable code such as HTML, MXML, Java, ActionScript, and/or other suitable software code. Display page 130 may be further operable to pass parameters (e.g., embedded resource ID, user ID, etc.) to and receive responses from server 114. Based on these responses, display page 130 may generate at least a portion of a display and/or dynamically update at least a portion of a display. For example, display page 130 may pass user requests received through GUI 120 to Flash application 132 for updating a portion of display page 130.

Flash application 132 comprises any software component operable to execute Flash-based logic associated with one or more display pages 130. For example, Flash application 132 may be a Flex Application loaded by Flash player 128 and instantiated/rendered in GUI 120. In addition, Flash application 132 may perform calculations for generating graphic elements embedded in display pages 130. In some embodiments, Flash application 132 may be a client-side program based on logic defined in associated display files 140 and written or based on any appropriate programming language. For example, Flash application 132 may be based, at least in part, on code written in MXML, MXML-based, and MXML-compatible languages and, alone or in combination, on code written in ActionScript, ActionScript-based, and ActionScript-compatible languages. MXML is often used to declaratively lay-out the interface of applications, such as one embedded in display page 130. ActionScript is typically used in combination with MXML and is used to implement business logic associated with an application. In some embodiments, Flash application 132 is operable to receive parameters (e.g., HTTP Service(s), Named param/value pair, others), invoke calls to server 114, receive responses from server 114, perform calculations based, at least in part, on received data, and/or generate displays for presenting through at least a portion of display page 130. In the case of HTTP Service(s) parameters, Flash application 132 may invoke a HTTP Data Service(s) to load associated Flash models. Such models (e.g., XML models) provided by Data Services may be bound to or otherwise associated with local models in Flash application 132. In doing so, Flash application 132 may operate on the local copy of models independent of server 114. In other words, operating on local models may reduce, minimize or eliminate network traffic between client 112 and server 114 since client 112 performs the operations not server 114. Flash application 132 may have multiple models which are retrieved from different Data Services. In this case, Flash application 132 may bind to the models provided by the Data Services. In some embodiments, the HTTP Data Services comprises XML over HTTP. For example, Flash application 132 may invoke one or more of the following data services:

Data Service HTTP Request Table:

| Parameter | Value |
|---|---|
| SERVICE_ACTION | Name of the Service operation requested |
| FORMAT | Format of operation paramters (xml) [For future] |
| REQUEST | Operation parameters (xml payload) |
| | <request> |
| | ... |
| | </request> |

Data Service HTTP Response Table:

| Parameter | Value |
|---|---|
| FORMAT | Format of response (xml) [For future] |
| RESPONSE | Response (xml payload) |
| | <response> |
| | ... |
| | </response> |

It will be understood that the table above is for illustration purposes only. System 100 may use some, all, or different attribute translations without departing from the scope of this disclosure. In this case, data include in the Flash model may be stored inside the Flash client as local models. In some embodiments, Flash application 132 may interact with server 114 during its life cycle. For example, Flash application 132 may invoke Data Service(s) directly on server 114 to update itself and/or trigger server-side events and update other areas on the displayed page.

In addition, events may be propagated between Flash application 132 and the container display page 130. In some embodiments, events raised by Flash application 132 may be converted into a standard event object including one or more of the following properties: Event Comp Id—ID of the component who triggered the event; Event Comp Name—Name of the component who triggered the event; Event name—logical name of the event; Event Type: Type of event; or Event Context (set of parameters may be passed transparently as name/value pairs). In this case, the standard event object may be available to the javascript method that handles the event raised by Flash application 132.

In the Flex-application embodiments, system 100 may translate between Flex attributes and Business Server Pages (BSP) HTML for Business (HTMLB) for communication between Flash application 132 and display page 130. In general, HTMLB provides a set of Web controls including controls, their types, usage, attributes, and how to set the attributes with the JSP-taglib and the classlib. In this case, the following table illustrates an example translation between Flex attributes and HTMLB attributes:

Translation Table

| Event | | |
|---|---|---|
| Attribute | BSP HTMLB Event Attribute | Flex Event Attribute |
| compName | htmlbEvent | target.name |
| compId | event_Id | target.Id |
| type | event_type | type |
| paramCount | NA | NA |
| context | Param1 = | context |
| (Array) | <param1>:<value1>,<param2>:value2...} | Array{<param1>:<value1>,<param2>:value2...} |
| | event_class = CL_BSP_HTMLB_EVENT | |
| name | event_server_name = ‘SERVER_EVENT’ | target.name_type |

It will be understood that the table above is for illustration purposes only. System 100 may use some, all, or different attribute translations without departing from the scope of this disclosure. In some embodiments, a ActionScript/JavaScript Channel may be established to serve as a conduit for invoking JavaScript functions from ActionScript functions and vice-versa. In other words, events fired by ActionScript in Flash application 132 may be propagated to JavaScript and methods invoked from JavaScript on Flash content object may be propagated to ActionScript. ActionScript/JavaScript channel may be a JavaScript/ActionScript library which is downloaded on client 112 and embedded into Flash application 132 to work transparently through a set of well defined ActionScript/JavaScript functions. It will be understood that while Flash application 132 is illustrated as a submodule of display page 130, Flash application 132 and display page 130 may comprise separate modules and/or may comprise a child or submodule of another software module without departing from the scope of this disclosure.

Server 114 is typically a computer that receives request for services and information from clients 112 and communicates responses to these request. In the illustrated embodiment, server 114 includes network interface 135, memory 136 and processor 138 comprises an electronic computing device operable to receive, transmit, process and store data associated with system 100. Although FIG. 1 provides one example of server 114 that may be used with the disclosure, server 114 can be implemented using computers other than servers, as well as a server pool. For example, server 114 may comprise a general-purpose personal computer (PC) a Macintosh, a workstation, a UNIX-based computer, a server computer, or any other suitable device. According to one embodiment, server 114 may comprise a web server. Server 114 may be adapted to execute any operating system including UNIX, Linux, Windows, or any other suitable operating system. In short, server 114 may comprise software and/or hardware in any combination suitable to provide access to display files 140 and/or translate data to a format compatible with Flash player 128.

Server 114 includes interface 135 for communicating with other computer systems, such as client 112 and foreign data sources 116, over network 118 in a client-server or other distributed environment. In certain embodiments, server 114 receives display pages 140 from network 118 for storage in memory 136. Generally, interface 135 comprises logic encoded in software and/or hardware and a suitable combination and operable to communicate with network 118. More specifically, interface 135 may comprise software supporting one or more communications protocols associated with communication network 118 or hardware operable to receive and transmit physical signals encoding request for and responses regarding information stored in memory 136.

Memory 136 may include any memory or database module and may take the form of volatile or non-volatile memory including, without limitation, magnetic media, optical media, RAM, ROM, removable media, or any other suitable local or remote memory component. In this embodiment, memory 136 includes display files 140 and data provider files 144. Display files 140 are associated with one or more dynamic or otherwise web pages including one or more Flash applications. Display files 140 may comprise a text file that uses tags and scripts written in MXML to generate the page layout. Display files 140 may include other suitable tags such as HTML tags, XML tags, HTML tags, JSP tags, or other tags. It will be understood that display files 140 may in combination or alternatively be scripted with MXML-based code, MXML-compatible code, or code performing MXML-like functions. In addition or alternatively, display file 140 may include code written in any suitable language to for executing logic associated with the request page. For example, display file 140 may include Java, ActionScript, or other suitable code for performing logic processes. MXML is what is used by Flex Server to be compiled into standard binary SWF files. Display files 140 may be created or modified by server 114, a third-party software vendor, or any other suitable user of any computer in system 100. Display files 140 may also be loaded from a default file or received via interface 122. Display files 140 may be noted by the extension “.swf” or any other suitable extension. In some embodiments, Display files 140 embeds a Flash component 142 associated with a portion of display files 140. Flash application 132 may be embed using an XML tag but may alternatively be a JSP-based tag, JSP-compatible tag, or any other suitable command inserted in a file.

Flash component 142 is associated with one or more Flash applications embedded in a web page. For example, Flash component 142 may include code for providing a Rich Internet Application embedded in a web page. In this case, Flash component 142 describes logic for execution on the client-side that may provide Flash applications having the features and functionality of traditional desktop applications. In some embodiments, Flash component 142 is a Flex Application developed using Flex Builder or any other suitable IDE/Editor that may be compiled into the Flash format. Flash component 142 may written in any appropriate object-oriented programming language. In some embodiments, Flash component 142 uses MXML, MXML-based, and MXML-compatible languages to declaratively lay-out the interface of one or more Flash applications embedded in a web page, such as display page 130. Alone or in combination, Flash component 142 includes code written in ActionScript, ActionScript-based, and ActionScript-compatible languages for implementing business logic on the client side. Flash component 142 may include one or more of the following tags: Id: Unique Id of the flash Content on the page (a javascript object with this Id is available with methods, properties and events defined by the developer); eventEnabled: true|false (whether event bubbling is enabled or not); on Event: javascript event handler for outgoing events (default event handler for events generated by Flash content. If no event handler is provided, an HTMLB event may be sent to the server.); params: comma separated list of parameters as <name>:<value> pairs; dataServices: Data Service used by the Flex Application (<namedService1>:URL;<namedService2:URL . . . ); styles: stylesheet link; height: height of flash mime; or width: width of flash mime. Display files 144 and/or Flash component 140 may be dynamically created or populated by server 114, a third-party vendor, any suitable user of server 114, loaded from a default file, or received via network 118. The term “dynamically” as used herein, generally means that the appropriate processing is determined at run-time based upon the appropriate information.

Each application profile 144 comprises instructions, mappings, algorithms, or any other directive for processor 138 to identify aspects of one or more Flash applications embedded in a requested web page. Application profile 144 may identify information for accessing, retrieving, and processing information stored in foreign data sources 116. For example, application profile 144 may include technical information such that processor 138, using the technical information, may access and retrieve data from, for example, a column of a database table stored in foreign data source 116 often without requiring recoding of processor 138 or input from the user. Technical information may include one or more of the following: a network address, login information, a database server name, a database name, a data source name, a database table name, a column name, database commands, keys or identifiers contained in native data, or other foreign data source identifiers or information associated with retrieving and/or processing foreign data. In addition, application profile 144 may include logical data such that processor 138, using the logical data, may modify, convert, or otherwise translate foreign data to a form compatible with Flash player 128. As a result, in some embodiments of the present disclosure, application profiles 144 eliminates the need for the user to know technical details of a foreign data source 116 such as, for example, a database name, a table name, a column name, a link column, database schema, and others. In this case, a user may be unaware that they are accessing a foreign data source 116 and/or the origin of presented data.

Each application profile 144 may be associated with a Flash application 132 or multiple application profiles 144 may be associated with a single Flash application 132. Application profile 144 may be any suitable format such as, for example, a text file, binary file, an XML document, a flat file, a comma-separated-value (CSV) file, a name-value pair file, a Structured Query Language (SQL) table, one or more libraries, or others as long as processor 138 communicably coupled with application profiles 144 is operable to as least partially open, read, manage, and/or operated application profiles 144. Application profile 144 may be dynamically created or populated by client 112, a third-party vendor, any suitable user of server 114, loaded from a default file, or received via network 118. In addition, application profiles 144 may be created, deployed, and maintained independently of processor 138 and/or associated foreign data sources 116. Accordingly, the foreign data available to processor 138 may be expanded and/or enhanced by adding or enhancing application profiles 138, typically without modifying or altering the binary modules of processor 138 or the associated foreign data sources 116.

Processor 138 executes instructions and manipulates data to perform operations of server 114. Although FIG. 1 illustrates a single processor 138 in server 114, multiple processors 138 may be used according to particular needs, and reference to processor 138 is meant to include multiple processors 138 where appropriate. In the illustrated embodiment, processor 138 includes or executes flash transformer 146 and view controller 148. View controller 148 may receive requests 113 and processes application profiles 144. Regarding the illustrated embodiment, view controller 148 receives and decodes client request 113 for display pages 130 associated with a dynamic web page. In response to a client request 113, view controller 148 may compile the requested display 142 into one or more associated display pages 130. View controller 148 may include any hardware, software, firmware, or combination thereof operable to receive client request 113 and generate display pages 130. It is understood that view controller 148 is illustrated as a single multi-task module, but the features and functionality performed by this engine may be performed by multiple modules.

Flash transformer 146 is any suitable application running on server 114 that is operable to invoke application profiles 144 for retrieving data from foreign data sources 116 and translating the foreign data to a form compatible with Flash player 128. In response to a request to retrieve data from foreign data source 116, flash transformer 146 may identify one or more application profiles 144 associated with a requested display page 130 and retrieve technical information for retrieving foreign data from appropriate foreign data sources 116. After retrieving the foreign data, flash transformer 146 may translate the foreign data to a form compatible with Flash player 128. In some embodiments, flash transformer 146 translates the foreign data to XML. In connection with translating foreign data, flash transformer 146 may perform calculations, in accordance with the identified application profiles 144, using the retrieved data prior to transmitting display pages 130 to client 112. It will be understood that while Flash engine 148 and flash transformer 146 are illustrated as a single multitasked module, the features and functionality performed by these engines may be performed by multiple modules such as a request engine, a compiler, and others. Moreover, Flash engine 148 and flash transformer 146 may comprise a child or submodule of another software module, not illustrated, without departing from the scope of this disclosure.

Each foreign data source 116 is generally any logical or physical data repository, whether local or remote, that is foreign to Flash player 128. Examples of foreign data source 116 include relational databases, object-oriented databases, file systems, document storage systems, or any other suitable storage or data structure. In one example, foreign data sources 116 comprise relational database servers including a relational database typically accessed through SQL statements. In this example, foreign data source 116 may be any computer or processing device such as, for example, a blade server, a server pool, general-purpose personal computer (PC), Macintosh, workstation, Unix-based computer, or any other suitable device. Foreign data sources 116 may be adapted to execute any operating system including Linux, UNIX, Windows Server, or any other suitable operating system. In another example, foreign data source 116 may also be the object-oriented database, Btrieve files, flat files, CSV files, text files, and/or other data structures or objects. In yet another example, foreign data source 116 may be a data repository, structure not directly accessible or compatible with Flash player 128. Put another way, player 128 may have been coded to be compatible or interact with a first version of a data structure, while being at least slightly incompatible with a second (older or newer) version of the same data structure (foreign data source 116).

In one aspect of operation, display engine 134 displays items such that a user may make a select certain display pages for display. For example, display engine 134 may display a tree hierarchy that the user may select the content and type of report that for presenting through GUI 120. In response to the selection by the user, display engine 134 transmits a request to view controller 148 for the selected display pages 130. In the example, the user of display engine 134 may request various charts for displaying sales opportunity information as well as new customer information (e.g., pie chart, bar graph, table, line graph). In response to at least the request, view controller 148 automatically identifies display files 140 associated with the request display pages 130. In addition, view controller 148 may identify application profiles 144 associated with the selected applications. Returning to the example, view controller 148 may identify a display file 140 including the various charts request by the user. In this case, view controller 148 may identify an application profile 144 associated with each chart. In accordance with the information identified in the chart, view controller 148 may transmit a request for foreign data to foreign data sources 116. After receiving the foreign data, flash transformer 146 translates foreign data to a form compatible with Flash application 132. View controller 148 may perform calculations on the data in accordance with the technical information included in application profiles 144. For example, view controller may determine percentages, aggregate data, or perform other suitable mathematical and/or logical operations. In the event, the associated display files 140 and Flash components 142 are compiled into display pages 130 and Flash applications 132, respectively. View controller 148 transmits the request pages and associated data to display engine 134. Display engine 134 presents the container display pages 130 and Flash player 128 executes the Flash applications 132 for presenting the foreign data.

FIG. 2 illustrates an embodiment of processor 138 in accordance with one embodiment of the present disclosure. At a high level, processor 138 includes a plurality of modules such as, for example, Personalization Framework 202, User Session Management 204, Report Content Provider 206, Flash Transformer 146 and Report Result Caching Framework 208. But, of course, these sub-modules are for example purposes only and processor 138 may include none, some, or all of the illustrated sub-modules as well as other sub-modules. Moreover, one or more of the sub-modules may be remote to, dynamically linked to, or physically or logically separated from the other sub-modules as appropriate.

Personalization Framework 202 is any software operable to provide user specific customization of views, both in terms of data as well as the look and feel. For example, an application may displays to the user information associated with a company such as company name, company address and the financial data of the company. A different user or the same at a different time may not want the company address to be displayed, then personalization framework 202 enables the user the flexibility to remove that block or field from the view.

User Session Management 204 is any software that may provide a unique non sharing session for each user. User Session Management 204 may also ensure that each request of the same user is identified as originating from that user. In doing so, User Session Management 204 can be process a requested action in accordance with previous actions.

Report Content Provider 206 is any software operable to provide a report including foreign data in response to at least a request from client 112. For example, Report Content Provider 206 may receive a request for display pages 130 and, in response to at least the request, identify associated display files 140 and associated provider files 144. Report Content Provider 206 may retrieve foreign data from foreign data source 116 in accordance with the associated provider files. After Flash Transformer 146 translates any foreign data to the Flash format (discussed below), Report Content Provider 206 may generate the requested display pages 130 based, at least in part, on the associated display files 140 and the translated data.

Flash Transformer 146 is any software operable translate foreign data to a form compatible with Flash player 128. In some embodiments, Flash Transformer 146 identifies provider files 144 associated with the request foreign data. Flash Transformer 146 may identify instructions, algorithms, or any other directive used to map foreign data to the Flash format using the provider files 144. After translating the foreign data, Flash Transformer 146 may pass the translated data to Report Content Provider 206 for integrating into the request display pages 130.

Report Result Caching Framework 210 is any software operable to cache display pages 130 before they are sent to client 112. In the event of future request for the display pages 130, Report Result Caching Framework 210 may retrieve the display pages 130 directly from the cache before sending them to client 112.

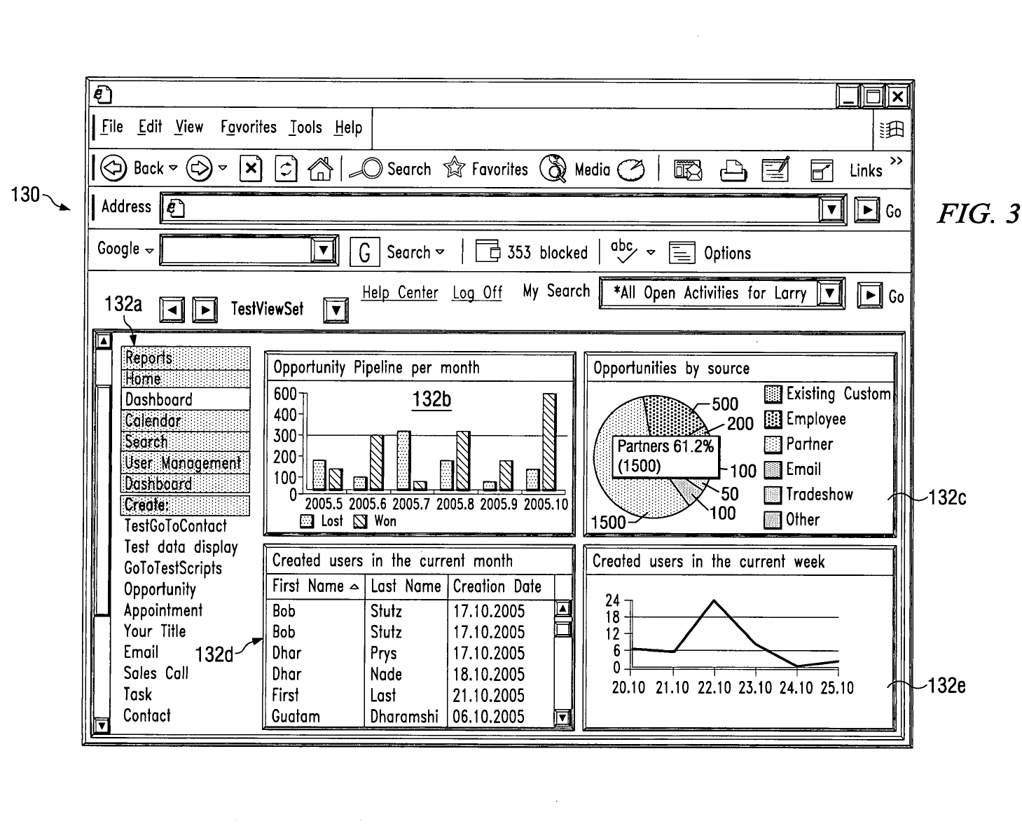

FIG. 3 illustrates an example display page 130 including embedded Flash applications 132a-e. Generally, display page 130 provides a user with a view of foreign data using Flash applications 132a-e. It will be understood that illustrated web page 130 is for example purposes only. Accordingly, GUI 120 may include or present data, such as foreign data, in any format or descriptive language and page 130 may present any appropriate data in any layout without departing from the scope of the disclosure.

Referring to the illustrated embodiment, display page 130 includes the embedded Flash applications 132a-e. Flash applications 132a-e may be displayed in a single window or in their own window. Flash application 132a presents a tree structure that enables conventional expanding and contraction (i.e., explore-type behavior). Selections made in Flash application 132a enable the user to dynamically update display page 130. Flash application 132b illustrates a bar graph indicating both the number of lost and won opportunities for a number of months. The x-axis indicates the year and month and the y-axis indicating the number of opportunities either lost or gained in that month depending on the color of the bar. Flash application 132c presents a pie chart illustrating the number of opportunities that the enterprise has won as a function of source. The different sources are indicated by different colors or patterns and their pie section is sized in accordance with their percentage of opportunities. Flash application 132d presents a tabular display, including several rows and columns, with each intersection comprising a cell. Each cell is populated with information associated with new users associated with a month. Each, as used herein, means every one of at least a subset of the identified items. In the illustrated embodiment, the table includes three columns: First Name, Last Name, and Creation Date. Flash application 132e presents a graph illustrating the number of users in the last week. The x-axis indicates the date and the y-axis indicates the number of users on that date. Flash applications 132a-e indicate that different operations that may be performed in the same source of foreign data. As discussed above, client 112 may receive translated data but Flash applications 132a-e may generate and present different displays based, at least in part, on the same data. Since Flash applications 132a-e reside on client 112, any computations on the translated data may be performed independent of server 114.

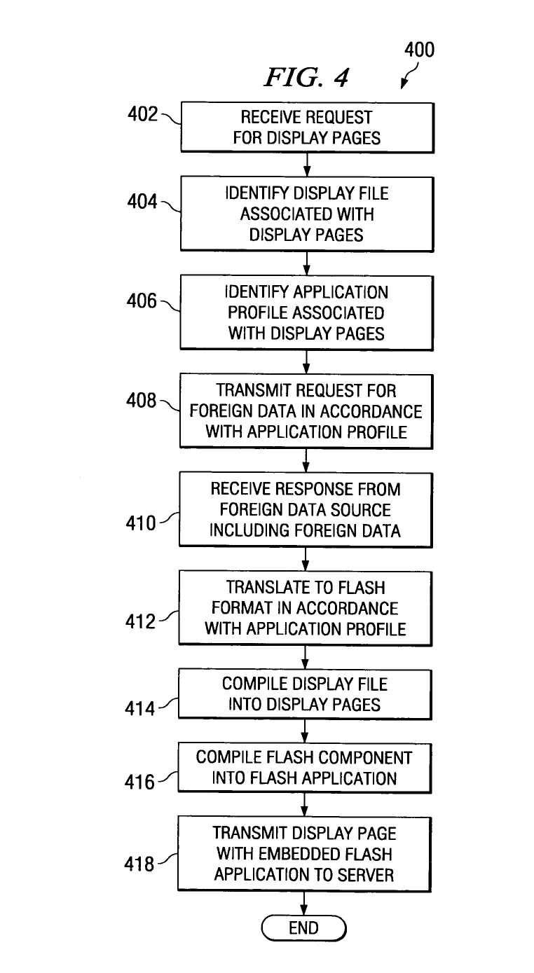

FIG. 4 is a flow diagram illustrating an example method 400, respectively, for managing information in system 100. Method 400 is described with respect to system 100 of FIG. 1, but method 400 could be used by any other device or components. Moreover, system 100 may use other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Method 400 begins at step 402 where view controller 148 receives a request for display pages 130 from client 102. For example, view controller 148 may receive a request for pages including sales information associated with a business. In response to at least the request, view controller 148 identifies display files 140 and application profiles 146 associated with the request pages 130 at step 404 and 406, respectively. In a sales example, application profile 146 may indicate that the requested pages include foreign data displayed associated with Flash application 132. At step 408, view controller 148 transmits a request for foreign data to foreign data source 116 in accordance with application profile 146. For example, view controller 148 may identify a network address, access information, and information indicating the location of the information. Next, at step 410, view controller 148 receives a response from foreign data source 116 including foreign data. In response to at least receiving the foreign data, flash transformer 146 automatically translates the foreign data to a form compatible with Flash player 128 (e.g., XML). Display files 140 are compiled into display pages 130 at step 414. In some embodiments, display files 140 include a tag for embedding Flash application 132 in display page 130. At step 416, Flash component 142 is compiled into Flash application 132. At step 418, view controller 148 transmits the request display pages and the embedded Flash applications 132 including any translated data.

Although this disclosure has been described in terms of certain embodiments and generally associated methods, alternatives and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A software application embedded in a computer-readable medium, the software operable to:
receive a request for a display page including data foreign to a Flash application embedded in the display page;
in response to at least the request, automatically identify technical information for retrieving the foreign data;
retrieve foreign data from at least one foreign data source in accordance with the technical information; and
translate the foreign data to a form compatible with the Flash application based, at least in part, on the technical information.

2. The software of claim 1, further operable to generate the requested display page including at least a portion of the translated data.

3. The software of claim 2, the software further operable to determine one or more calculations based, at least in part, on the foreign data and the technical information, wherein the display page is generated in accordance with the one or more calculations.

4. The software of claim 1, wherein software operable to translate the foreign data to a form compatible with the Flash application comprises software operable to translate the foreign data to an extensible Markup Language (XML) format.

5. The software of claim 1, wherein the at least one data source comprises a plurality of data sources, the software further operable to merge the translated data from the plurality of foreign data sources.

6. The software of claim 5, wherein the display page comprises a report generated by the Flash application and including the translated data from the plurality of foreign data sources.

7. The software of claim 1, wherein the display page comprises HTML.

8. A method for integrating foreign data into a Flash-based user interface, the method comprising:
receiving a request for a display page including data foreign to a Flash application embedded in the display page;
in response to at least the request, automatically identifying technical information for retrieving the foreign data;
retrieving foreign data from at least one foreign data source in accordance with the technical information; and
translating the foreign data to a form compatible with the Flash application based, at least in part, on the technical information.

9. The method of claim 8, further comprising generating the requested display page including at least a portion of the translated data.

10. The method of claim 9, further comprising determining one or more calculations based, at least in part, on the foreign data and the technical information, wherein the display page is generated in accordance with the one or more calculations.

11. The method of claim 8, further comprising translating the foreign data to a form compatible with the Flash application comprises translating the foreign data to an extensible Markup Language (XML) format.

12. The method of claim 8, wherein the at least one data source comprises a plurality of data sources, the method further comprising merging the translated data from the plurality of foreign data sources.

13. The method of claim 12, wherein the display page comprises a report generated by the Flash application and including the translated data from the plurality of foreign data sources.

14. The method of claim 1, wherein automatically identifying technical information further comprises using an application profile to identify information for accessing, retrieving, or processing information stored in the at least one foreign data source.

15. A system, comprising:
a view controller operable to receive a request for a display page including data foreign to a Flash application embedded in the display page;
a Flash transformer operable to:
automatically identify the technical information for retrieving the foreign data in response to at least the request;
retrieve foreign data from at least one foreign data source in accordance with the technical information; and
translate the foreign data to a form compatible with the Flash application based, at least in part, on the technical information.

16. The software of claim 15, the view controller further operable to generate the requested display page including at least a portion of the translated data.

17. The software of claim 16, the Flash transformer further operable to determine one or more calculations based, at least in part, on the foreign data and the technical information, wherein the display page is generated in accordance with the one or more calculations.

18. The software of claim 15, wherein software operable to translate the foreign data to a form compatible with the Flash application comprises software operable to translate the foreign data to an extensible Markup Language (XML) format.

19. The software of claim 15, wherein the at least one data source comprises a plurality of data sources, the software further operable to merge the translated data from the plurality of foreign data sources.

20. The method of claim 19, wherein the display page comprises a report generated by the Flash application and including the translated data from the plurality of foreign data sources.
